(19) United States
(12) Patent Application Publication
(10) Pub. No.: US 2017/0321465 A1
(43) Pub. Date: Nov. 9, 2017

(54) A DAMPING OR RETURN DEVICE FOR SLIDING DOOR LEAVES OR FOR DRAWERS

(71) Applicant: BORTOLUZZI SISTEMI S.P.A., Belluno (IT)

(72) Inventors: Guido BORTOLUZZI, Belluno (IT); Adriano GIROTTO, Spresiano (IT); Lucio MOLINER, Santa Giustina (IT)

(73) Assignee: BORTOLUZZI SISTEMI S.P.A., Belluno (IT)

(21) Appl. No.: 15/525,684

(22) PCT Filed: Nov. 6, 2015
(86) PCT No.: PCT/EP2015/075975

§ 371 Date: May 10, 2017

(30) Foreign Application Priority Data
Nov. 11, 2014 (IT) MI2014U000345

(51) Int. Cl. E05F 5/00

(52) U.S. Cl. CPC E05F 5/003; E05Y 2900/20; E05Y 2201/46; E05Y 2900/132

(57) ABSTRACT

A damping or return device for sliding door leaves, particularly for furniture, or for drawers, which is constituted by a pin the shank of which is constituted by a diametrically differently-polarized magnet that slideably and axially interacts with a steel plate or a complementarily-shaped collar, which is made of steel and polygonal

The present invention relates to a damping or return device for sliding door leaves, of the type with co-planar closure or otherwise, particularly for furniture and the like, or for drawers.

Nowadays as an alternative to usual, hinged doors, solutions are known for sliding doors that can be applied both to wardrobes and pieces of furniture in general, and also to door and window frames or to any other application of closing elements that require a reduced space when open.

Usually such types of door are constituted by one or more door leaves, each one of which has brackets with rolling means that are guided by a rail, which is constituted by an upper guide and by a lower guide, which respectively are applied to the ceiling and optionally to the floor of the compartment to be closed.

It is known to fit the door leaf with a device to return it to the open position, which can be disengaged as needed when it is desired to close the sliding door, or to the closed position, when it is desired that the door leaf follow a guided closure.

A problem that is found in conventional sliding door leaves is constituted by the fact that the door leaf can remain partially closed or partially open or it can slam, on the jambs of the door or on the sides of the item of furniture, when the door leaf is completely opened or completely closed.

Similar observations can be made for drawers.

A partial solution to such drawback is known from EP1658785 which discloses a device that is adapted to assist and guide the movement of a door leaf, which comprises a receptacle inside which is placed a damper, a spring, and an entrainment element that can be accommodated within a pair of teeth that are associated with a coupling element which comprises a guiding pin that can slide into an upturned L-shaped guide.

The device is arranged proximate to one end of the compartment.

For example, when opening the door leaf, at a certain point the device hooks the entrainment element that activates the damper until the pin is positioned, through the L-shaped guide, in a stable and stationary condition: when the door leaf is closed, the entrainment element interacts with the pair of teeth and activates the damper which thus gently accompanies the door up until the condition where it is completely closed.

Such solution however suffers some drawbacks: the device is in fact complex in terms of construction in that it is constituted by a plurality of elements that have to be put together in advance while paying great attention to the elements of play that exist for example between the L-shaped guide and the pin that rests in it, since any sticking or the creation of friction could defeat the operation of the device and thus prevent the correct closing or complete opening of the door leaf.

Furthermore, conventional return devices suffer other criticalities which are linked to the fact that the return spring does not have a constant force along its stroke.

This causes problems with the return along the final part of the stroke because the force is low and there are, inversely, problems with opening the door in the final part when the door is released, where the force of the spring is too high.

This, combined with the fact that the connection to the return mechanism of the door in motion occurs by way of mechanical means, creates bothersome noise in operation.

EP 2455571 is also known, which discloses a mechanism for forcible movement which comprises a first urging body to apply a force toward a certain position for a fixed body in a standby position.

A striker body is captured at a prescribed position by the fixed body which is held in standby position, and a movable body is moved up to a position at end of movement by way of the relative movement of the fixed body to the determined position by the release of the hold on the occasion of the capture.

A damping mechanism comprises a contact part for connection with the fixed body constituting the mechanism for forcible movement, a second body urging the contact part in an advancement direction.

The damping mechanism is constituted so as to apply a resistance to a retraction of the contact part accompanying the movement of the fixed body to the determined position.

Such solution suffers the same drawbacks mentioned previously.

EP 2557259 is also known, which discloses a braking device that comprises pneumatic braking means which can be activated by way of a slider interacting with a fixed frame, for example of the door; in one embodiment there is a piston the rod of which is provided, at the end tip, with a magnetic head the function of which is, once it has come into contact with a fixed L-shaped profile with one wing positioned head-on to the magnetic head, to allow the rod to be extracted from the stem of the piston.

Such solution suffers many drawbacks such as the considerable length required for the braking device, the stem of which is subject to possible breakage or sticking; furthermore, the reliability of the pneumatic functionality is poor.

Finally the sole function of the magnetic head is to directly couple to a fixed body, arranged along the same axis, for the extraction of the stem.

EP 2330269 is also known, which discloses a sliding guide for doors of wardrobes which has a damper stop comprising a trolley consisting of a first frame and a second frame shaped like an upturned “U” to which the upper ends of an outer or inner door are fixed.

The damper stop comprises an air or gas damper fixed outside two seats which are provided on a section associated with the trolley.

Such solution also suffers many drawbacks, such as the use of a gas damper which, moreover, is arranged laterally to the trolley so as to increase the space taken up and render the guide barely usable.

The aim of the present invention is therefore to resolve the above mentioned technical problems, by eliminating the drawbacks in the cited known art and hence providing an invention, which can be applied to sliding doors or door leaves or to drawers, which has a simple structure, which is free from sticking and which makes it possible to obtain the optimal closing and guided opening of the door or of the door leaf, while preventing the same from slamming against the wall of the item of furniture.

Within this aim, another important object of the invention is to provide a device that is easily applied to conventional door leaves or to conventional doors of furniture.

Another object is to provide a device the dimensions and weight of which are contained and which therefore is low cost.

Another object of the invention is to provide a device by which it is possible to contain the friction and elements of play in the various movements, thereby optimizing the movement and the sliding of the door leaf.

Another object is to provide an invention that is free from bothersome noises during its operation.

This aim and these and other objects which will become better apparent hereinafter are achieved by a damping or return device for sliding door leaves, particularly for furniture, or for drawers, which is characterized in that it is constituted by a pin the shank of which is constituted by a diametrically differently-polarized magnet that slideably and axially interacts with a steel plate or a complementarily-shaped collar, which is made of steel and polygonal in cross-section, in contrast with an elastically compressible element.

Further characteristics and advantages of the invention will become better apparent from the detailed description of a particular, but not exclusive, embodiment, which is illustrated by way of non-limiting example in the accompanying drawings wherein:

FIG. 1 is a perspective exploded view of a device according to the invention;

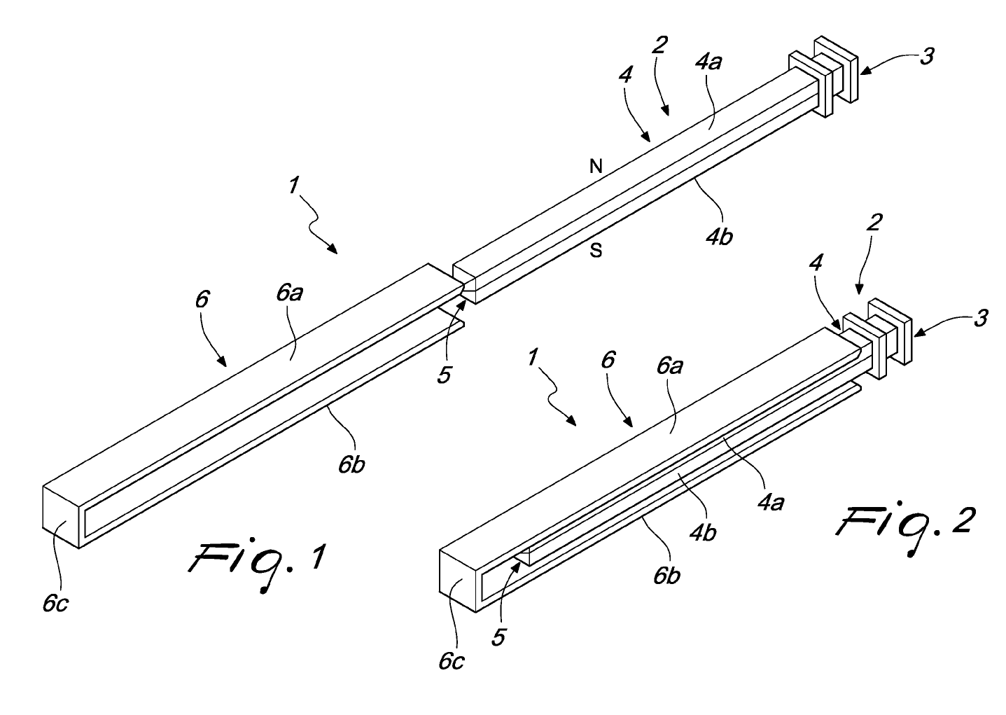

FIG. 2 is a perspective view of the device of FIG. 1;

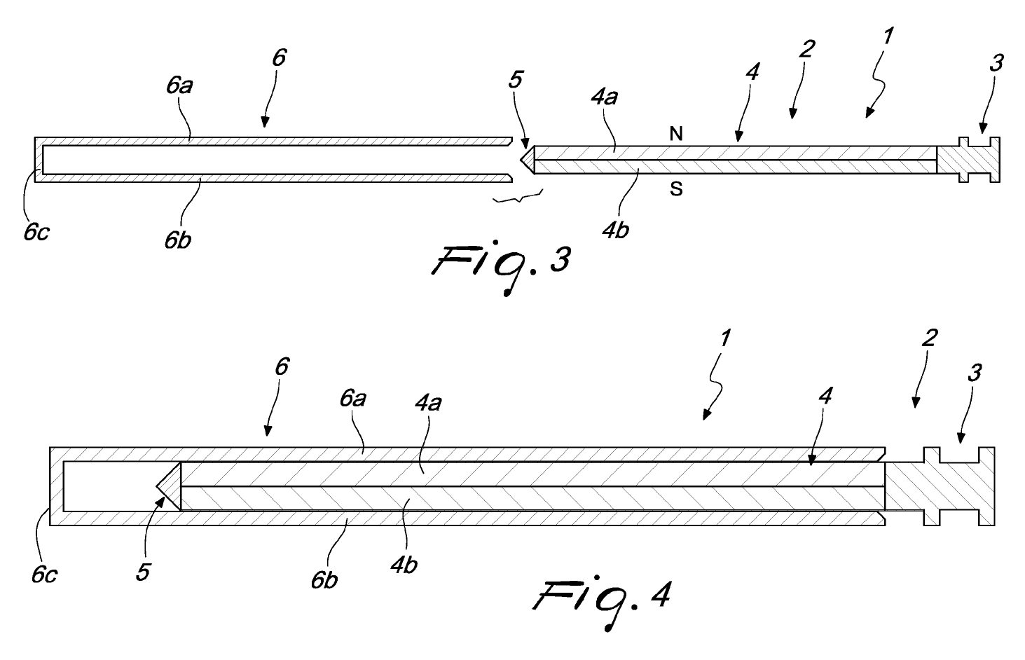

FIG. 3 is a cross-sectional view of the device of FIG. 1;

FIG. 4 is a cross-sectional view of the device of FIG. 2;

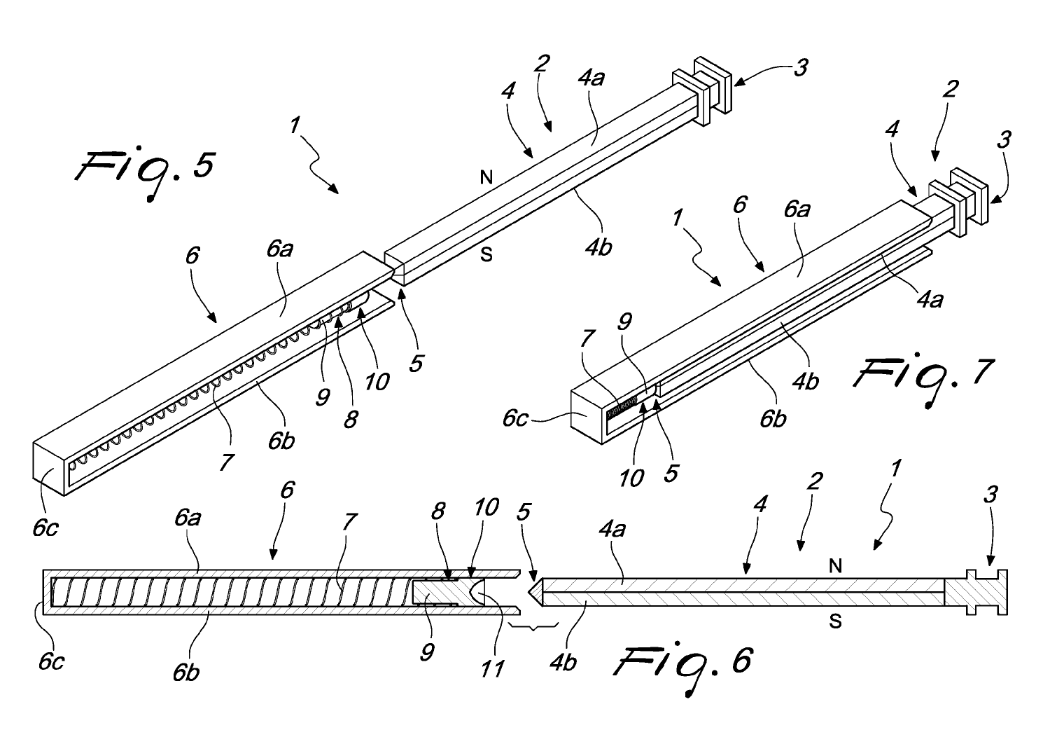

FIG. 5 is a view of a device which is similar to the view in FIG. 1 in which there is a damping element;

FIG. 6 is a view of the device which is similar to the view in FIG. 4 in which there is a damping element arranged inside the plate;

FIG. 7 is a view of the device which is similar to the view in FIG. 5 with the damping element compressed;

FIG. 8 is a perspective view of a different embodiment of the device according to the invention;

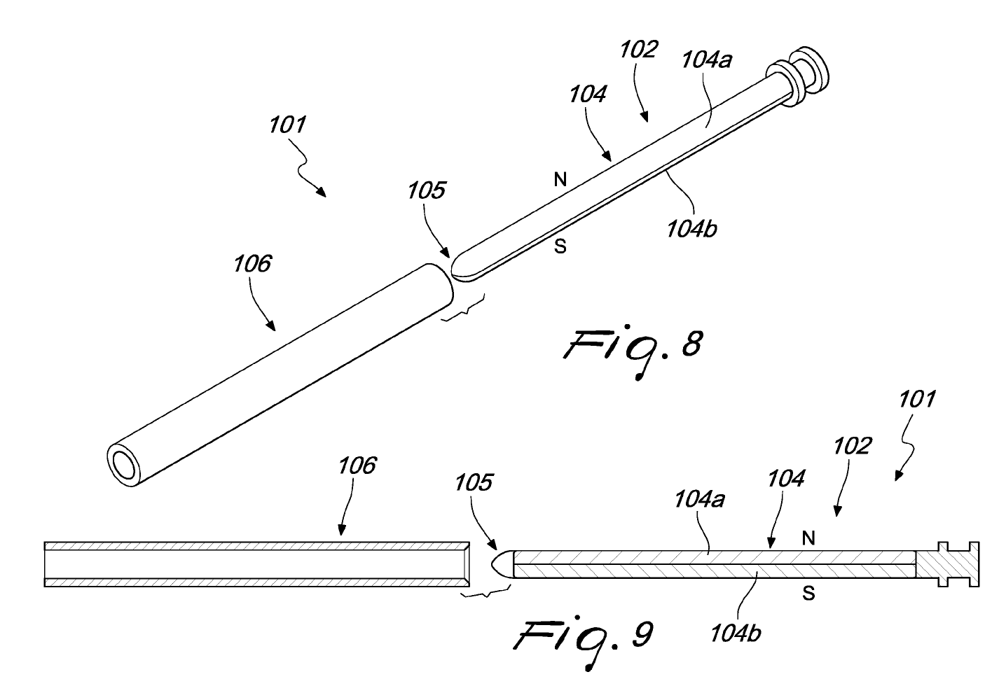

FIG. 9 is a view of the device of FIG. 8 which is similar to the view in FIG. 3;

FIG. 10 is a view of the device of FIG. 8 which is similar to the view in FIG. 6;

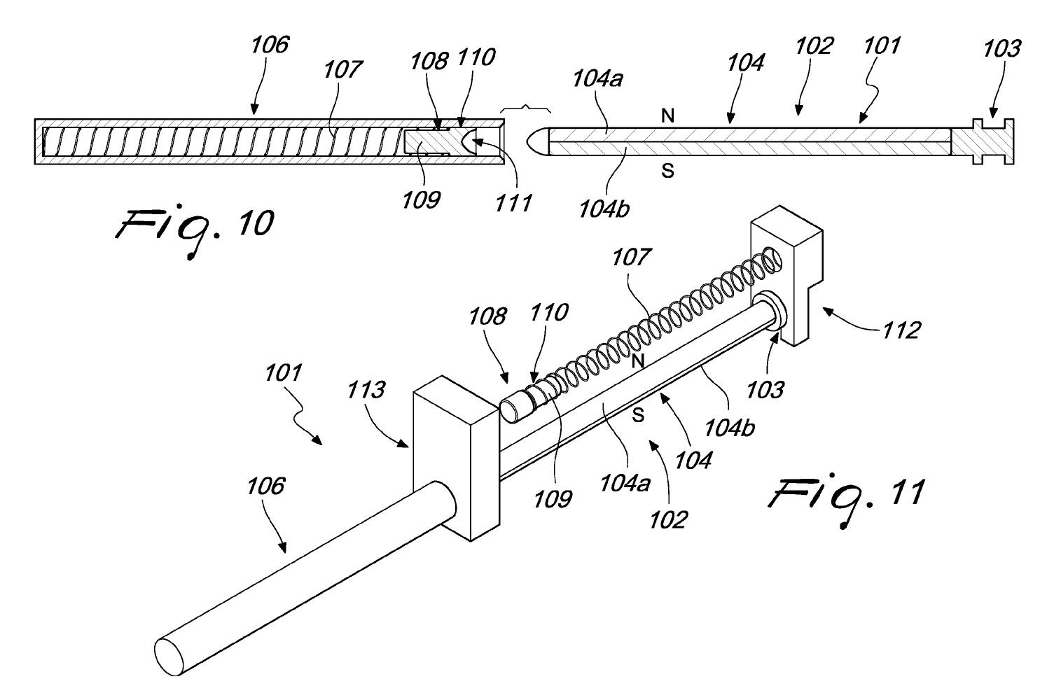

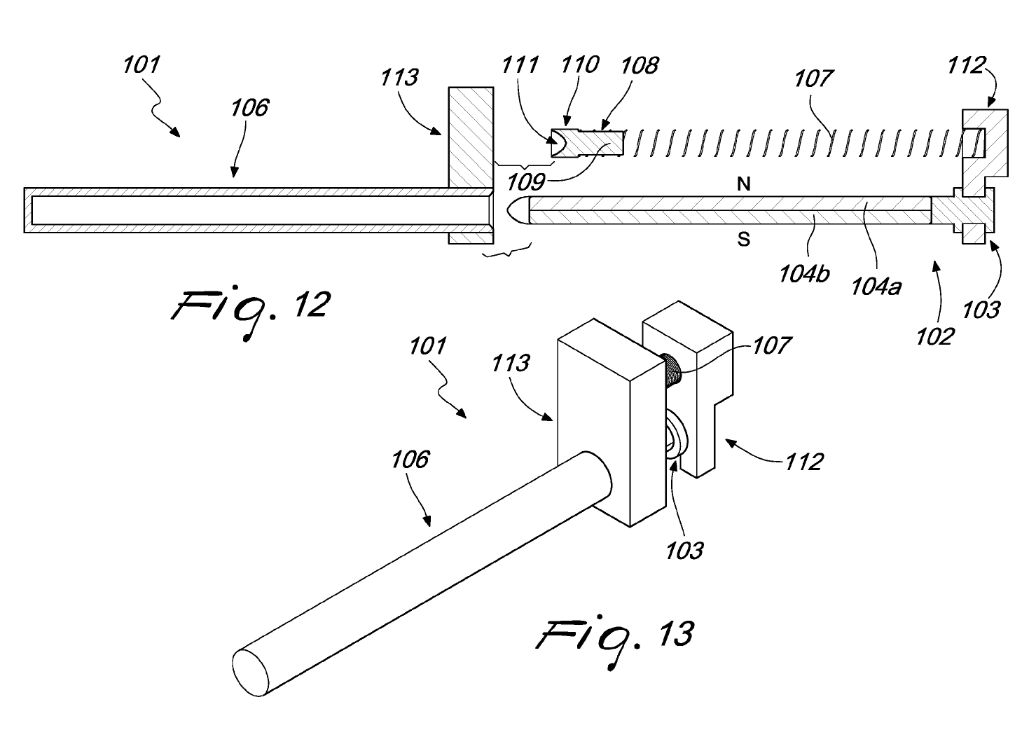

FIG. 11 is a perspective view of a further embodiment of the device according to the invention;

FIG. 12 is a cross-sectional view of the device in FIG. 11;

FIG. 13 is a view of the device which is similar to the view in FIG. 11 with the damping element compressed;

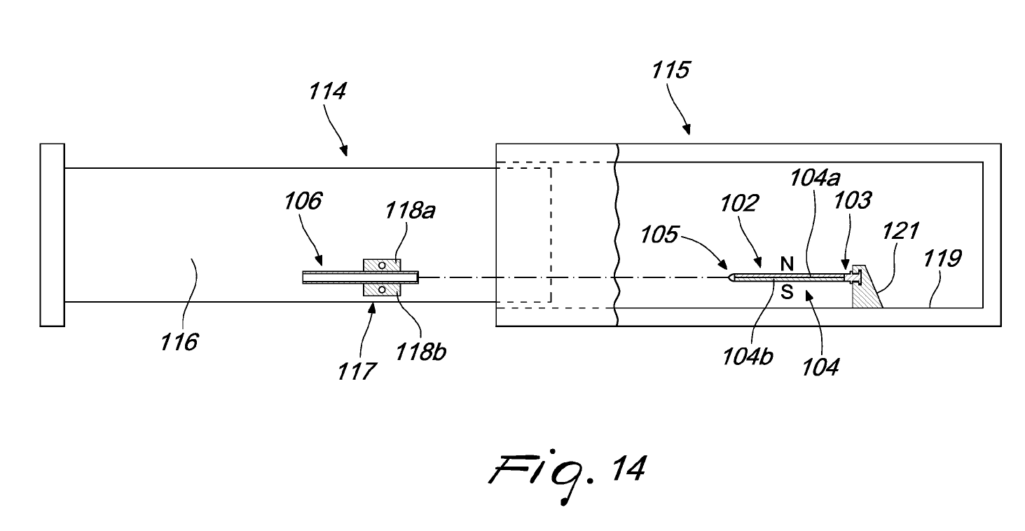

FIG. 14 is a side view of the device, cross-sectioned, applied to a drawer.

In the embodiments illustrated, individual characteristics shown in relation to specific examples may in reality be interchanged with other, different characteristics, existing in other embodiments.

Moreover, it should be noted that anything found to be already known during the patenting process is understood not to be claimed and to be the subject of a disclaimer.

With reference to the figures, the reference numeral 1 generally designates a device that is associated with a slideable door leaf, particularly for furniture and the like, or for drawers (not shown).

The device 1 is constituted by a pin 2 with a first head 3 which is polygonal, preferably square, in plan view with a H-shaped transverse cross-section, from which a polygonal, preferably square or rectangular, shank 4, diametrically polarized differently, protrudes axially, the end tip 5 of which is substantially V-shaped or rounded.

The shank 4 of the pin 2 is diametrically polarized differently: it is therefore, from the magnetic point of view, divided into a first half-shank 4a and a second half-shank 4b, which are coupled together and are mutually identical, are polygonal, preferably rectangular, in cross-section and have opposing polarities.

For example the first half-shank 4a has a north polarity N and the second half-shank 4b has a south polarity S.

Also going to make up the device 1 is a steel plate 6 which is C-shaped in cross-section so as to define a first wing 6a and a second wing 6b which, when the device is activated, are arranged facing toward, without contact, the half-shank 4a and the half-shank 4b.

The first wing and the second wing 6a, 6b therefore have dimensions and encumbrances which are such as to accommodate between them, without contact, the shank 4 of the pin 2 which can thus slide freely without sliding friction.

The plate 6 has a base 6c connecting the first wing and the second wing 6a, 6b.

The shank 4 of the diametrically differently-polarized pin 2 moves in contrast with a damping element 7 which is constituted for example by a spring arranged inside the steel plate 6.

In the embodiment shown in FIG. 5 the damping element 7 is arranged between the first wing and the second wing 6a, 6b; advantageously the length of the damping element 7 is shorter than that of the plate 6.

At the end 8 of the damping element 7 directed toward the end tip 5 of the pin 2, the complementarily-shaped shank 9 of an insert 10 which can slide between the first wing and the second wing 6a, 6b is axially inserted.

The insert 10 advantageously has a second head 11 which is shaped complementarily to the end tip 5 of the pin 2 in order to facilitate the mutual coupling.

As an alternative to the plate 6, a device 101 is shown which uses a collar 106, also made of steel, and polygonal, preferably cylindrical, in cross-section, which is shaped complementarily to the substantially cylindrical shank 104 of a pin 102 which is diametrically polarized differently so as to define a first half-shank 104a and a second half-shank 104b.

The shank 104 optionally operates in contrast with a damping element 107 at the end 108 of which that is directed toward the end tip 105 of the pin 102 the complementarily-shaped shank 109 of an insert 110 which can slide within the collar 106 is axially inserted.

The insert 110 advantageously also has a second head 111 which is shaped complementarily to the end tip 105 of the pin 102 in order to facilitate the mutual coupling.

Alternatively, the damping element 107 is associated with and protrudes at right angles from a first appendage 112 which is in turn associated with and protrudes radially from the first head 103 of the pin 102.

The damping element 107 is arranged substantially parallel to the shank 104 in the direction of the free end 105 of the shank 104.

The free end 108 of the damping element 107 interacts in abutment with a second appendage 113 which protrudes radially from the collar 106.

Operation of the device is as follows: after having obtained the diametrically differently-polarized pin 2, 102, in the final stage of closing a door leaf, with which the pin 2, 102 is associated, the shank 4, 104 penetrates inside the plate 6 or inside the collar 106 and is kept in axial alignment by it without there being sliding friction.

The end tip 5, 105 of the shank 4, 104 then interacts with the damping element 7, 107, if present, which slows the stroke thereof until it is stopped at the desired point when it reaches its stroke limit, optimally and continuously, and exerting a force that is constant both during closing and during opening.

The presence of the insert 10, 110 makes it possible to improve the sliding of the spring inside the collar and improve the compression and elongation phase of that spring.

If the device 101 is to be applied to a drawer 114 of the type with usual and conventional rails, not shown, for the sliding thereof with respect to a frame 115 of an item of furniture, it will be sufficient for the collar 106 to be associated with at least one of the outer lateral surfaces 116 of the drawer 114 by way of a first bracket 117 shaped like an Ω (omega) which is fixed with screws at perforated wings 118a, 118b to the lateral surface 116.

The pin 102 on the other hand is arranged parallel to a bottom 119 of the frame 115, at a height such as to bring it into axial alignment with the collar 106, by way of a second bracket 121 which is provided with means of coupling which are shaped complementarily to the head 103 of the pin 102.

In practice it has been found that the invention has fully achieved the intended aim and objects, a device being obtained that can be applied to sliding doors or door leaves or to drawers, including existing doors or door leaves or drawers, and is provided with a simple structure that, partly thanks to the use of the diametrically differently-polarized collar, is free from the presence of sliding friction between components and from sticking, thus making it possible to achieve the optimal guided closing and opening of the door or of the door leaf while preventing the same from slamming on the wall of the item of furniture.

Furthermore, the weight and dimensions and cost of the device are contained, while at the same time making it possible to contain the friction and elements of play in the various movements, so as to optimize the movement and the sliding of the door leaf or of the drawer.

Obviously the materials used as well as the dimensions of the individual components of the invention may be more relevant according to specific requirements.

The various means of achieving certain different functions certainly need not coexist only in the embodiment shown, but may be present in many embodiments, even if they are not shown.

The characteristics indicated above as advantageous, convenient or the like, may also be missing or be substituted by equivalent characteristics.

The disclosures in Italian Utility Model Application No. MI2014U000345 (202014902308352) from which this application claims priority are incorporated herein by reference.

Where technical features mentioned in any claim are followed by reference signs, those reference signs have been included for the sole purpose of increasing the intelligibility of the claims and accordingly, such reference signs do not have any limiting effect on the interpretation of each element identified by way of example by such reference signs.

1-10. (canceled)

11. A damping or return device for sliding door leaves or for drawers, comprising:
a pin the shank of which is constituted by a diametrically differently-polarized magnet that comprises mutually coupled first and second portions having opposing polarities and that slideably and axially interacts with a steel plate or a complementarily-shaped collar, which is made of steel and polygonal in cross-section, in contrast with an elastically compressible element.

12. The device according to claim 11, wherein the pin has a first head which is polygonal in plan view with a H-shaped transverse cross-section, from which the shank, diametrically polarized differently, and substantially square or rectangular, protrudes axially, an end tip of which is V-shaped or rounded.

13. The device according to claim 11, wherein the pin has a first head which is polygonal in plan view with a H-shaped transverse cross-section, from which the shank, diametrically polarized differently, and substantially circular, protrudes axially, an end tip of which is V-shaped or rounded.

14. The device according to claim 13, wherein the shank of the pin is diametrically polarized differently and is therefore, from the magnetic point of view, divided into a first half-shank and a second half-shank, which are coupled together and are mutually identical, being polygonal in cross-section and having opposing polarities, the first half-shank having a north polarity and the second half-shank having a south polarity.

15. The device according to claim 14, wherein the steel plate is C-shaped in cross-section so as to define a first wing and a second wing which, when the device is activated, are arranged facing toward, without contact, the first half-shank and the second half-shank, the first wing and the second wing having dimensions and encumbrances which are such as to accommodate between them, without contact, the shank of the pin which can thus slide freely without sliding friction, the plate having a base connecting the first wing and the second wing.

16. The device according to claim 11, wherein the shank moves in contrast with the elastically compressible element which is constituted by a spring which is arranged inside the plate or the complementarily-shaped steel collar or outside the plate or the complementarily-shaped steel collar.

17. The device according to claim 15, wherein the elastically compressible element, the length of which is shorter than that of the plate, is arranged between the first wing and the second wing or axially and inside the collar without sliding friction.

18. The device according to claim 15, wherein at an end of the elastically compressible element directed toward the end tip of the pin a complementarily-shaped shank of an insert which can slide between the first wing and the second wing or axially to the collar is axially inserted, the insert having a second head which is shaped complementarily to the end tip of the pin.

19. The device according to claim 18, wherein the elastically compressible element is associated with and protrudes at right angles from a first appendage which is in turn associated with and protrudes radially from the first head of the pin, the elastically compressible element being arranged substantially parallel to the shank in the direction of the end tip of the shank, the end tip of the elastically compressible element interacting in abutment with a second appendage which protrudes radially from the collar.

20. The device according to claim 13, wherein the complementarily-shaped collar is associated with at least one of outer lateral surfaces of a drawer of the type with rails for the sliding thereof with respect to a frame of an item of furniture, the complementarily-shaped collar being associated with at least one of the outer lateral surfaces by way of a first bracket shaped like an Ω (omega) which is fixed with screws at perforated wings to the lateral surface, the pin being arranged parallel to a bottom of the frame, at a height such as to bring it into axial alignment with the complementarily-shaped collar, by way of a second bracket which is provided with means of coupling which are shaped complementarily to the head of the pin.
